(19) United States
(12) Patent Application Publication
(10) Pub. No.: US 2011/0052297 A1
(43) Pub. Date: Mar. 3, 2011

(54) PRINTABLE FORM HAVING SEPARABLE TAPE-INTERCONNECTED SECTIONS PROVIDING IMAGE TRANSFER THEREBETWEEN

(75) Inventors: Gary A. Bosley, Fort Scott, KS (US); Phil R. Quick, Fort Scott, KS (US)

(73) Assignee: WARD-KRAFT, INC., Fort Scott, KS (US)

(21) Appl. No.: 12/552,101

(22) Filed: Sep. 1, 2009

(51) Int. Cl. B41J 15/00; B42D 15/00

(52) U.S. Cl. 400/611; 283/66.1

(57) ABSTRACT

A business form is provided for printing within a high-heat printer and transferring an impressed image between portions of the form. The form includes a first portion with a carbonless transfer coating applied to the rear face thereof, and a second portion with a carbonless transfer coating applied to the front face thereof. The portions are positioned in an edge-to-edge relationship adjacent one another, defining a seam therebetween, and are retained in such position with heat-resistant tape. The tape includes a perforation line that extends along the seam to facilitate folding therealong and easy separation of the portions from one another. The portions include indicia areas with preprinted indicia thereon positioned such that when the first portion is folded behind the second portion, the indicia areas and preprinted indicia precisely align and an impressed image created on the second portion is automatically transferred to the first portion. A method of forming the business form is also provided.

### BACKGROUND OF THE INVENTION

1. Field of the Invention

The present invention relates generally to a business form that is printable within a high-heat printer and provides impressed image transfer between portions of the form. More specifically, the present invention concerns a foldable form with multiple portions that automatically transfers an impressed image from one portion to another portion when one portion is folded behind another portion, with the portions being retained together with heat-resistant tape.

2. Discussion of the Prior Art

Those of ordinary skill in the art will appreciate that various industries face a need to fill out a form and have an image copy created immediately, without requiring a traditional photocopy to be made. Such an image copy form is frequently used by service or repair professionals (such as lawn care, pest control, auto repair, delivery tickets, and the like), where a copy of notes or options indicated by the service professional at the time of consultation can be made and left with the customer for record keeping.

Traditionally, image copy forms have been multiple-sheet forms that include a plurality of coextensive, full sheets initially joined together. A common design has been to secure the plurality of sheets along a top edge so that the plurality of sheets remain aligned and together during the execution of handwritten notes, numerals, check marks, and the like on a first top sheet. The construction of the form creates an image copy or copies on second or additional bottom sheets. After impression, the multiple sheets can then be separated, such as by tearing along a glued attachment portion along the top edge of the sheets.

Historically, these multiple-sheet forms have included a sheet of carbon paper disposed between successive copy sheets. Carbon paper is a lightweight tissue paper that has been coated with a carbon ink that will transfer an image to another sheet when pressure is applied. The carbon paper would act to transfer the image made on the first top sheet to the second sheet below the carbon paper. Multiple copies on additional bottom sheets can be created by including additional sheets of carbon paper between the additional sheet layers.

Multiple-sheet forms have also been created that eliminate the use of carbon paper, instead using a carbonless transfer paper to create the image transfer between successive sheets. Carbonless transfer paper is a paper that includes a chemical coating on the front side (designated in the industry as CF), on the rear side (designated in the industry as CB), or on both sides (designated in the industry as CFB). A conventional multiple-sheet form using two sheet layers of carbonless transfer paper is typically arranged with a top sheet having a CB coating on the rear side thereof and a bottom sheet underlying the top sheet and having a CF coating on the front side thereof. When a handwritten or machine impression is made on the top sheet, the impression transfers from the top sheet to the bottom sheet due to the bursting of tiny microcapsules in the chemical coating used to release a darkened copy of the impression occurring on the top sheet.

Other conventional multiple-sheet forms using more than two sheet layers of carbonless transfer paper are typically arranged as above with additional intermediate sheets between the top and bottom sheets having a CFB coating on both the front and rear sides thereof. In this way, the intermediate sheets both accept the impressed image from the sheet above and transfer the impressed image to the next sheet below. Many such forms include sheets with a CFB coating even on the top and bottom sheets, such that all of the layered sheets of the form include the same carbonless transfer coatings thereon.

While carbonless forms have alleviated the need for a carbon paper sheet layer between successive sheet layers, these products have retained the conventional layered construction of multiple, coextensive, full sheets, often requiring complex alignment and securement of the multiple sheets used in a single form. Those of ordinary skill in the art will also appreciate that the continued use of multiple-sheet forms results in associated production and material costs for such complex arrangements, as well as adding to the amount of paper waste commonly found in printing environments and landfills.

### SUMMARY

The present invention provides a business form that comprises multiple distinct portions and provides an impressed image transfer between distinct portions of the form when one portion is folded behind another portion. The distinct portions of the form are secured together with a heat-resistant tape such that the entire form is printable within a high-heat printer to create printed material on parts of the form.

According to one aspect of the present invention, a foldable business form is provided that is printable within a high-heat printer and provides image transfer between portions of the form. The form includes a first portion formed from a first web and a second portion formed from a second web. The first and second portions cooperatively form opposite substantially continuous printable surfaces, and are positioned in anon-overlapping, edge-to-edge relationship with one another to define a seam therebetween. The first portion presents a first primary indicia area on one of the printable surfaces and the second portion presents a second primary indicia area on the other one of the printable surfaces such that the primary indicia areas are located on different portions and on opposite printable surfaces. The primary indicia areas each include preprinted indicia, and are cooperatively oriented such that, when the form is folded about the seam and the portions superimposed, one primary indicia area underlies the other primary indicia area and the preprinted indicia are aligned between respective primary indicia areas. The first and second portions each include a carbonless transfer coating applied to the same surface of both portions such that, when the preprinted indicia are aligned between respective primary indicia areas, an impressed image created on the primary indicia area of one portion is automatically transferred to a corresponding location on the primary indicia area of the other portion. The form further includes tape retaining the first portion and the second portion in the edge-to-edge relationship. The tape is heat resistant such that the tape is capable of maintaining adhesion and thereby substantially retaining the first portion and said second portion in the edge-to-edge relationship without fracturing as the form is passed through the printer. The tape includes a line of weakness therein defined at least partly along the seam to facilitate folding of the form at the seam and separation of the portions from one another.

Another aspect of the present invention concerns a method of forming a foldable business form product that is printable within a high-heat printer and provides image transferability between portions of the form by feeding first and second continuous substrate webs along a longitudinal path, with each of the webs including a carbonless transfer coating applied to a face thereof, aligning the first and second webs in a non-overlapping, edge-to-edge relationship to define a seam therebetween, with the seam extending along and being at least generally parallel to the path, and applying a continuous streamer of tape to the webs over and along the seam to retain the webs in the edge-to-edge relationship to thereby form a common continuous sheet having opposite substantially continuous printable surfaces, with the coated faces of the webs being presented along a common one of the printable surfaces so that, when the form is folded at the seam to orient the faces against one another, an impressed image created on one of the webs is automatically transferred to the other one of the webs, wherein the tape is heat resistant such that the tape is capable of maintaining adhesion and thereby substantially retaining the webs in the edge-to-edge relationship without fracturing when the business product is passed through the printer, and wherein the tape includes a line of weakness therein defined at least partly along the seam to facilitate folding of the form at the seam and separation of the webs from one another.

This summary is provided to introduce a selection of concepts in a simplified form that are further described below in the detailed description of the preferred embodiments. This summary is not intended to identify key features or essential features of the claimed subject matter, nor is it intended to be used to limit the scope of the claimed subject matter.

Various other aspects and advantages of the present invention will be apparent from the following detailed description of the preferred embodiments and the accompanying drawing figures.

### BRIEF DESCRIPTION OF THE DRAWING FIGURES

A preferred embodiment of the present invention is described in detail below with reference to the attached drawing figures, wherein:

FIG. 1 is a front elevational view of a business form product constructed in accordance with the principles of a preferred embodiment of the present invention, including a form comprising an upper first portion and a lower second portion joined edge-to-edge along a seam and adhered at the seam with a heat-resistant tape, and depicting printed indicia on the front face of each of the portions;

FIG. 2 is a rear elevational view of the business form product of FIG. 1, showing the heat-resistant tape overlying the seam with a perforation line in the tape disposed along the seam, and depicting printed indicia on the rear face of the first portion;

FIG. 3 is a side sectional view of the business form product of FIG. 1, taken substantially along line 3-3 of FIG. 1, showing the seam between the first and second portions and the heat-resistant tape underlying the seam, and depicting schematically a CF coating applied to the rear face of the first portion and a CB coating applied to the rear face of the second portion;

FIG. 4 is an isometric view of the business form product of FIG. 1, with the first portion having been folded about the seam into a disposition partially behind the second portion, showing the printed indicia on the rear face of the first portion aligning with the printed indicia on the front face of the second portion;

FIG. 5 is a side sectional view of the business form product of FIG. 1, with the first portion having been folded about the seam into a disposition behind the second portion, and depicting schematically the CF coating on the first portion underlying the CB coating on the second portion; and

FIG. 6 is an isometric view of the business form product of FIG. 1, with the first portion being partially separated from the second portion by tearing along the perforation line of the heat-resistant tape.

The drawing figures do not limit the present invention to the specific embodiments disclosed and described herein. The drawings are not necessarily to scale, emphasis instead being placed upon clearly illustrating the principles of the preferred embodiments.

### DETAILED DESCRIPTION OF THE PREFERRED EMBODIMENTS

The present invention is susceptible of embodiment in many different forms. While the drawings illustrate, and the specification describes, certain preferred embodiments of the invention, it is to be understood that such disclosure is by way of example only. There is no intent to limit the principles of the present invention to the particular disclosed embodiments.

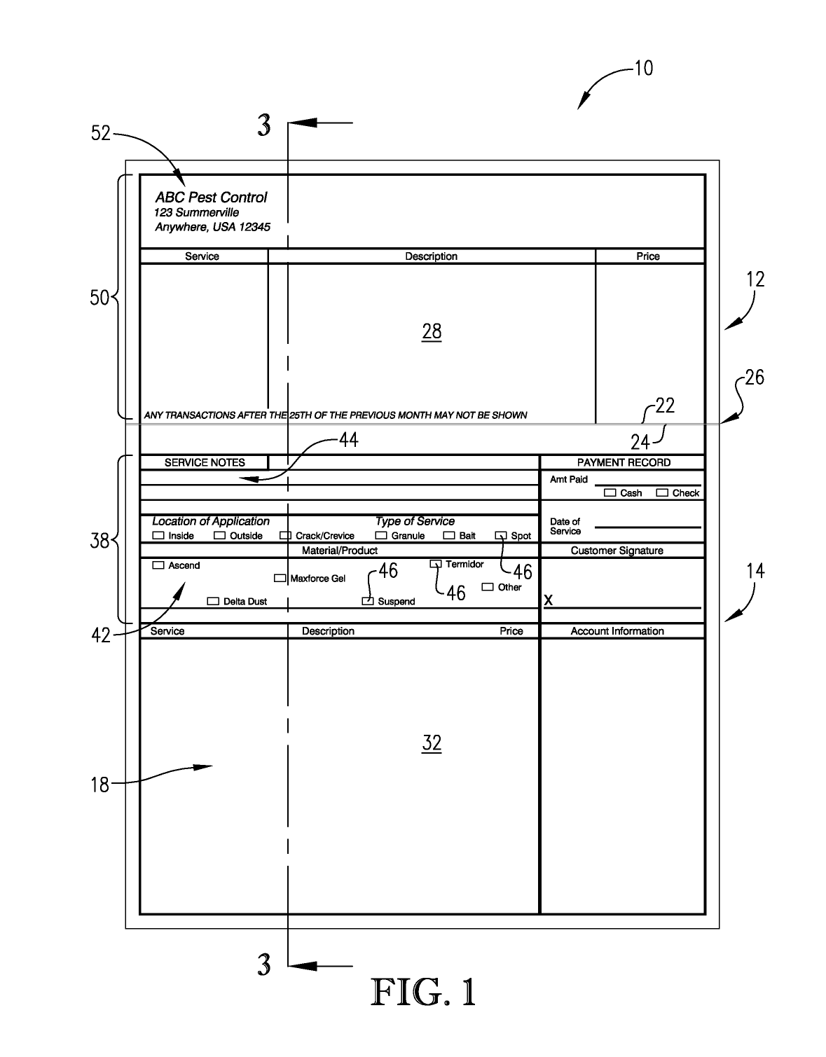

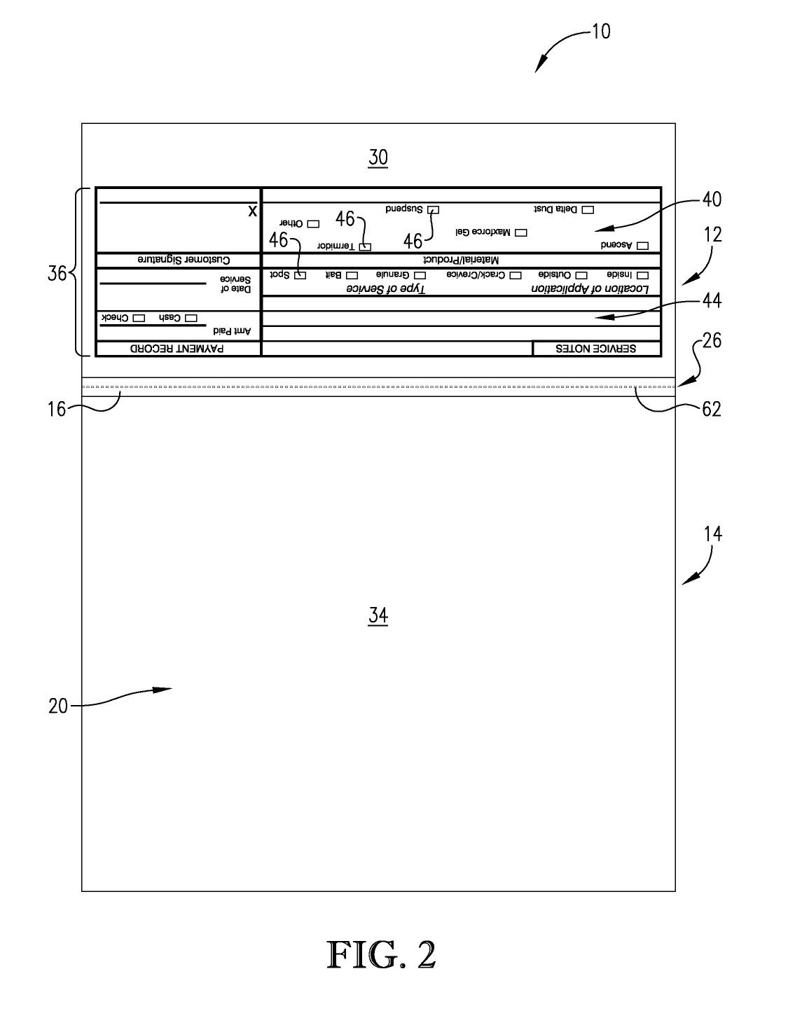

With initial reference to FIGS. 1 and 2, a foldable business form 10 constructed in accordance with a preferred embodiment of the present invention is illustrated with printed indicia thereon. The form 10 broadly includes a first portion 12 and a second portion 14 interconnected with heat-resistant tape 16, as described in detail below.

The depicted form 10 provides impressed image transfer between the portions 12, 14 to automatically create a copy of impression marks created on one of the portions (the second portion 14 in the depicted embodiment) on the other one of the portions (the first portion 12 in the depicted embodiment). It is initially noted that the form 10 of the illustrated embodiment is a single ply form including two portions 12, 14 so that two total images (one original and one copy) are created during use. Should more than two copies be desired, an alternative form could include additional portions formed and joined together in the manner described herein to produce more copies. Alternatively, either instead of or in conjunction with such additional portions, one or more portions could comprise multiple layers or plies configured to transfer an image therebetween (e.g., an alternative first portion including two plies could be joined to the second portion 14 depicted herein), as will be readily appreciated by one of ordinary skill in the art upon review of this disclosure. Such alternative and the like for producing more than two copies would not depart from the teachings of the present invention.

The illustrated form 10 is generally formed by aligning two continuous webs and joining the webs with a streamer of heat-resistant tape to form a continuous roll. The illustrated form 10 is an individual form that has been preprinted and sheeted from such a continuous roll and is configured to be printed in a high-heat printer, such as an offline laser printer, by an end user. The principles of the present invention, however, are not limited to preprinted, sheeted forms, but also apply equally to other business form products, including a continuous roll, either before or after preprinting. It is noted that while the illustrated form 10 is formed by merging two continuous webs (corresponding to the first portion 12 and the second portion 14 upon sheeting), an alternative form including the merging of more than two webs is within the ambit of the present invention.

With continued attention to FIGS. 1 and 2, the form 10 is a bisectional, generally rectangular form presenting opposite substantially continuous printable surfaces 18, 20. In other words, the form 10 can be fed into a single printing system to print the entire surface 18, the entire surface 20, or both surfaces 18, 20, in one application. In the depicted embodiment, the form 10 is a standard letter-size form (i.e., 8.5″ by 11″), although other sizes and/or shapes for an alternative form are of course available without departing from the teachings of the present invention.

Turning now to additional details of the first portion 12 and the second portion 14, it is initially noted that in the depicted form 10, the portions 12, 14 are disposed as upper and lower portions, with the first portion 12 being disposed immediately above the second portion 14. This depicted arrangement is by way of example only, as alternative arrangements between portions (such as side-by-side) may be alternatively configured, as will be readily appreciated by one of ordinary skill in the art upon review of this disclosure.

The first portion 12 is generally rectangular in shape and includes a lower edge 22 that is substantially straight. The second portion 14 is also generally rectangular in shape and includes an upper edge 24 that is substantially straight. While the portions 12, 14 are depicted as rectangles, other shapes/sizes for alternative forms are within the ambit of the present invention. The edges 22, 24 present similar lengths and are disposed in anon-overlapping, edge-to-edge relationship with one another to define a seam 26 between the edges 22, 24 of the portions 12, 14. The first portion 12 and the second portion 14 are retained in such positional relationship by the heat-resistant tape 16, which joins the portions 12, 14 together and spans the seam 26 as described in detail below. It is also noted that additional numbers of portions (e.g., an alternative form could include three or more separable portions) are within the ambit of the present invention.

The first portion 12 presents opposite first faces, depicted as a first front face 28 and a first rear face 30. The second portion 14 presents opposite second faces, depicted as a second front face 32 and a second rear face 34. As depicted in FIGS. 1 and 2, the first front face 28 and the second front face 32 cooperatively form the substantially continuous printable surface 18, while the first rear face 30 and the second rear face 34 cooperatively form the substantially continuous printable surface 20.

In the illustrated embodiment, the first portion 12 and the second portion 14 each comprise paper that cooperatively provide a directional impressed image transfer, as explained in detail below. It is noted that the portions 12, 14 may be formed of papers or other materials of different color, brightness, finish, and/or thickness and the like in order for an end user to quickly and easily distinguish between the portions 12, 14. It is further noted that alternative forms may include portions made of materials other than conventional papers (such as laminated materials) without departing from the teachings of the present invention.

The first and second portions 12, 14 each include a primary indicia area 36, 38, respectively, disposed on opposite sides thereof. As depicted on the form 10 of the illustrated embodiment, the first primary indicia area 36 is disposed on the first rear face 30 of the first portion 12 (as shown in FIG. 2). The second primary indicia area 38, which is located on the surface opposite the first primary indicia area 36, is disposed on the second front face 32 of the second portion 14 (as shown in FIG. 1).

In the illustrated embodiment, both of the primary indicia areas 36, 38 include adjacently spaced preprinted indicia 40, 42, respectively, thereon. As can be seen in FIGS. 1 and 2, the preprinted indicia 40 on the first primary indicia area 36 and the preprinted indicia 42 on the second primary indicia area 38 are substantially identical, although such correspondence between the entireties of preprinted indicia 40, 42 is not necessary. Nonetheless, as will be readily appreciated by one of ordinary skill in the art upon review of this disclosure, at least some correspondence between preprinted indicia 40, 42 can provide significant benefits to the operation of the form 10. The preprinted indicia 40, 42 provide image spaces that are configured to receive handwritten annotations thereon, as described below.

In more detail, the preprinted indicia 40, 42 include location-specific content, such as a lined note area 44 and pluralities of adjacently spaced check boxes 46. Moreover, the preprinted indicia 40 on the first rear face 30 of the first portion 12 is reflected about the seam 26 relative to the preprinted indicia 42 on the second front face 32 of the second portion 14. In other words, when the form 10 is positioned in a flat condition (as illustrated in FIGS. 1 and 2), and the preprinted indicia 42 on the second portion 14 is oriented right side up (see FIG. 1), then the preprinted indicia 40 on the first portion 12 is oriented upside down (see FIG. 2).

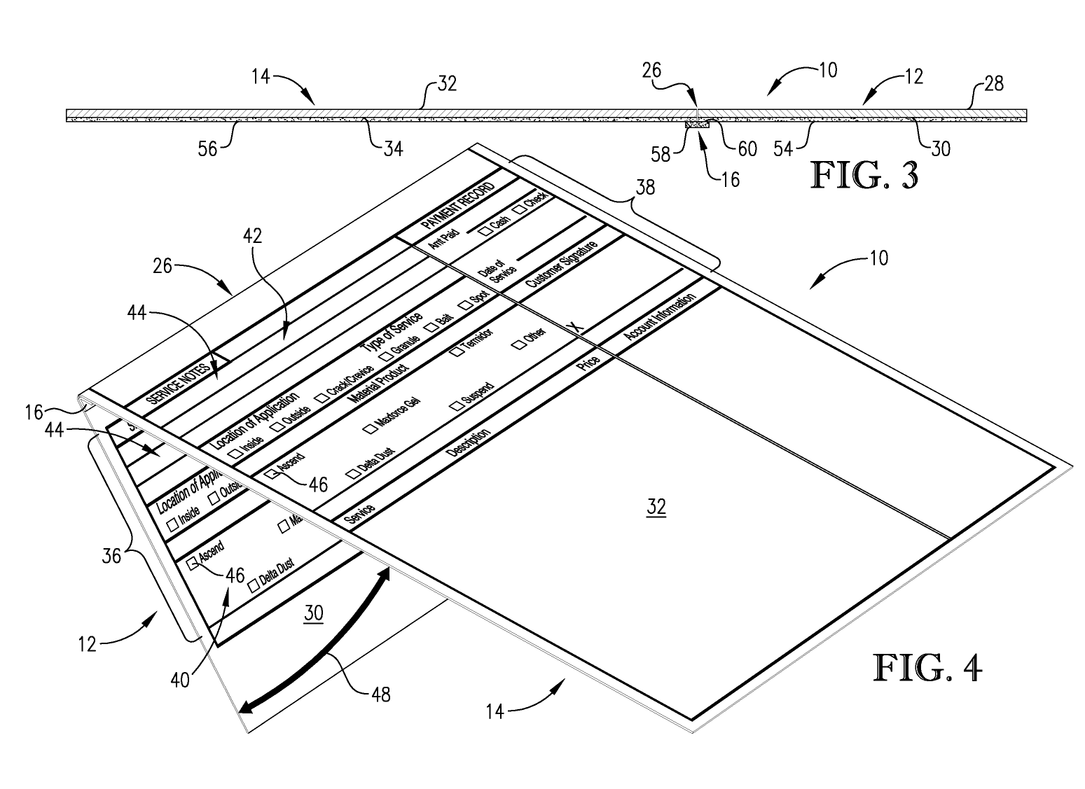

Turning briefly now to FIG. 4, it can be seen that when the first portion 12 is folded about the seam 26 into it a disposition behind the second portion 14 (as illustrated by folding direction arrow 48), then the first primary indicia area 36 underlies the second primary indicia area 38. Furthermore, when the form 10 is in such a folded condition, the preprinted indicia 40, 42 are precisely and reliably aligned one on top of another (such that, for example, the lined note area 44 and check boxes 46 of the second preprinted indicia 42 exactly overlie corresponding lined note area 44 and check boxes 46 of the first preprinted indicia area 40). Such reliable precise alignment of the preprinted indicia 40, 42 is an important function of the portions 12, 14 being folded about the defined seam 26, as will be readily appreciated by one of ordinary skill in the art upon review of this disclosure.

Returning briefly FIGS. 1 and 2, the form 10 of the illustrated embodiment also includes a first secondary indicia area 50 with preprinted secondary indicia 52 disposed thereon. The first secondary indicia area 50 is disposed on the first front face 28 of the first portion 12, such that the indicia 52 is printed on the same continuous printable surface 18 as the indicia 42 of the second primary indicia area 38 on the second portion 14. It is noted that the preprinted second indicia 52 on the first secondary indicia area 50 has no corresponding preprinted indicia or indicia area on the second portion 14; however, the inclusion of such corresponding indicia on an alternative form is of course within the ambit of the present invention.

With attention now to FIG. 3, the form 10 is illustrated schematically to depict the first and second portions 12, 14 each including a carbonless transfer coating 54, 56, respectively, applied thereto. In particular, the carbonless transfer coatings 54, 56 are applied to the same continuous printable surface 20 of the form 10. In more detail, the first portion 12 preferably includes a carbonless front (CF) coating 54 applied to the first rear face 30 thereof, and the second portion 14 preferably includes a carbonless back (CB) coating 56 applied to the second rear face 34 thereof.

The CF and CB coatings 54, 56 are chemical coatings that can be applied to the portions 12, 14 during formation of the form, as discussed below, or that can be preapplied to paper used to produce the portions 12, 14. As will be understood by one of ordinary skill in the art, a CF coated surface is capable of accepting, but not transferring, a pressure-transferred image, while a CB coated surface is capable of transferring, but not accepting, a pressure-transferred image. Furthermore, an alternative portion including a carbonless transfer coating applied to both the front and the back (CFB) could be used in place of either or both the depicted first and second portions 12, 14 without departing from the teachings of the present invention. The principles of the present invention further contemplate other alternative image transfer coatings, as may be suitable for the inventive form described herein.

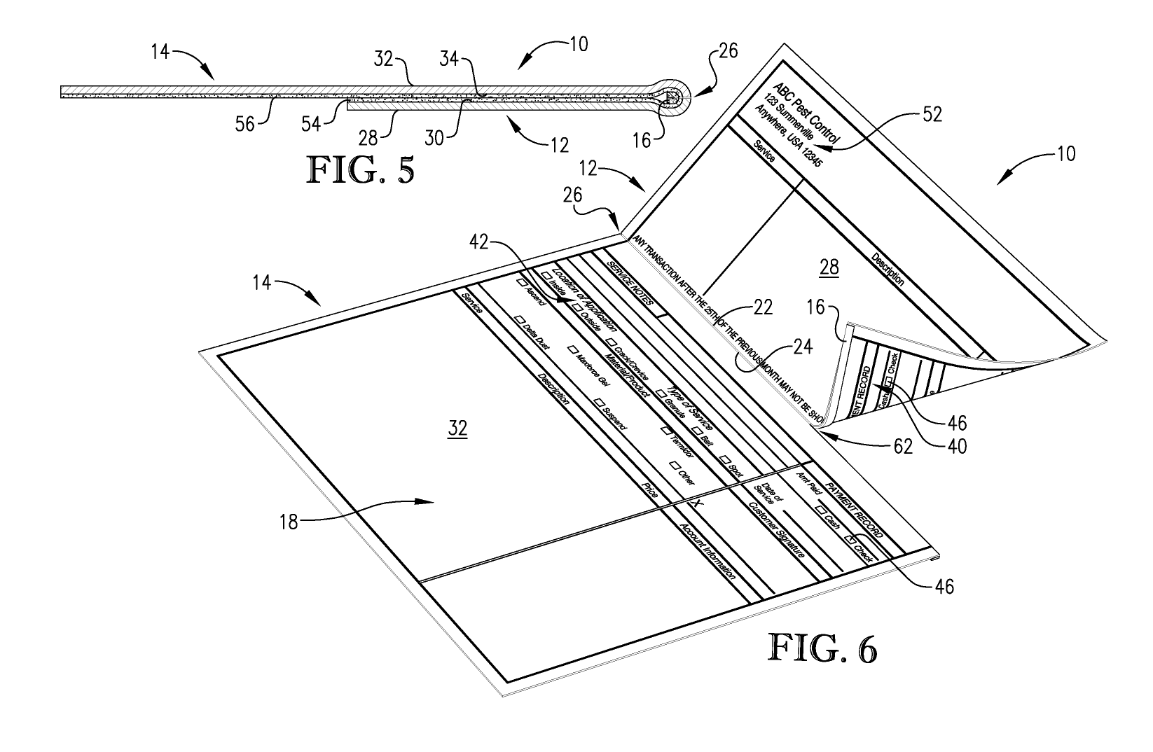

It is noted that in the depicted embodiment, the first rear face 30 of the first portion 12 and the second rear face 34 of the second portion 14 are both entirely covered with the CF and CB coatings 54, 56, respectively. Such extensive coverage, however, is not necessary, so long as the relevant indicia areas 38, 36 are sufficiently coated to effect the image transfer, as will be readily understood by one of ordinary skill in the art upon review of this disclosure. In particular, the CF coating 54 on the first portion 12 is located at least partly within the first primary indicia area 36, and the CB coating 56 is located in at least partial alignment with the CF coating 54 when the form 10 is folded as shown in FIGS. 4 and 5, in order to effect the desired image transfer.

Thus, when the form 10 is folded such that the first portion 12 is folded behind the second portion 14 about the seam 26 to thereby underlie the first portion 12, as described in detail above, an image impressed on the second primary indicia area 38 of the second portion 14 is automatically transferred to a corresponding location on the first primary indicia area 36 of the first portion 12. In this way, annotations or other marks indicated by an end user of the form 10, particularly those made on the preprinted indicia 42 of the second portion 14 (such as service notes made in the lined note area 44 or marking an “X” in any of the check boxes 46) are instantly copied over to the preprinted indicia 40 of the first portion 12.

As described above, the first and second portions 12, 14 each comprise paper. In one embodiment, the first portion 12 may comprise paper formed with the CF coating preapplied thereto (known in the industry as CF paper), and the second portion 14 may comprise paper with the CB coating preapplied thereto (known in the industry as CB paper). One suitable CF paper is available as 20 CF MM3992 from Appleton of Appleton, Wis., and one suitable CB paper is available as 20 CB MM4783 from Appleton of Appleton, Wis. Alternatively, either or both of the first and second portions 12, 14 may comprise paper or other material with a CFB coating thereon, as will be readily appreciated by one of ordinary skill in the art upon review of this disclosure.

With continued reference to FIG. 3, a heat-resistant tape 16 is shown underlying the seam 26 to thereby retain the first portion 12 and the second portion 14 in the non-overlapping, edge-to-edge relationship described above. The tape 16 is heat-resistant so as to be capable of maintaining adhesion and thereby substantially retaining the first portion 12 and the second portion 14 in the edge-to-edge relationship without the tape 16 fracturing as the form 10 is passed through a high-heat printer. In particular, the heat-resistant tape 16 is capable of maintaining adhesion without fracturing at all ambient temperatures up to one-hundred seventy-five degrees Fahrenheit, and particularly between the ranges of one-hundred and one-hundred seventy-five degrees Fahrenheit.

The tape 16 generally includes a backing layer 58 and an adhesive layer 60. As illustrated in FIG. 3, the adhesive layer 60 is fixed to a section of the first portion 12 and a section of the second portion 14 on the rear face 30, 34, respectively, of each of the portions 12, 14. In this way, the heat-resistant tape 16 is fixed to the continuous printable surface 20 of the form 10 along which the carbonless transfer coating 54, 56 is applied.

The tape 16 further includes a line of weakness, shown specifically in the form of a perforation line 62, extending therealong. As shown particularly in FIG. 2, the perforation line 62 lies along the seam 26 in order to facilitate easy removal of the first portion 12 from the second portion 14, as described in detail below. Alternative suitable lines of weakness, such as a score line (not shown) are within the ambit of the present invention, as will be readily appreciated by one of ordinary skill in the art upon review of this disclosure.

It is also noted that the tape 16 is generally flexible, such that when the first portion 12 is folded behind the second portion 14, as described above, the form 10 “hinges” about the seam 26 while being held together by the tape 16. It is further noted that while the tape 16 is shown schematically in FIG. 3 as having appreciable thickness, such illustration is for exaggerated illustrative purposes only, with it being readily understood by one of ordinary skill in the art upon review of this disclosure that the tape 16 is sufficiently thin so that the substantially continuous printable surface 20 is able to pass through a printer and be printed. By way of example, one suitable tape is available as Polybond Tape—114m (identified as “Lazer” heat-resistant tape) from Polybond Sales Corporation of Derry, N.H.

The operation of the illustrated form 10 should be apparent from the foregoing and, therefore, will be described here only briefly. As depicted in FIGS. 1 and 2, the form 10 includes preprinted indicia 40, 42 thereon, and additional indicia can be added to the form 10 by an end user by printing the form 10 on a high-heat printer, such as an offline laser printer. With particular reference to FIGS. 4-6, the form 10 is manipulated so that the first portion 12 is folded behind the second portion 14 about the seam 26, which precisely lines up the preprinted indicia 40, 42. When the first portion 12 underlies the second portion 14 such that faces 30, 34 of the same continuous printable surface 20 are adjacent one another, the form 10 can lie flat (as shown in FIG. 5).

During use of the form 10, after folding as described above, handwritten or otherwise impressed image marks, such as service notes made in the lined note area 44 or marking an “X” in any of the check boxes 46 (impressed image marks not shown) may be printed on the form 10. As described in detail above, the impressed image marks made on the second front face 32 of the second portion 14 are automatically transferred to a corresponding location on the first rear face 30 of the first portion 12. Thereafter, the first portion 12 and the second portion 14 can be separated by tearing along the perforation line 62 (as shown in FIG. 6). This separation allows one of the portions (such as the first portion 12) to be left with a customer, while the other of the portions (such as the second portion 14) may be retained by the user for record keeping.

It is noted that an alternative embodiment of the form 10 could include carbonless transfer coatings applied to the front of the form, such as the continuous printable surface 18. In such an alternative embodiment, the first portion 12 may include a carbonless back (CB) coating applied to the first front face 28 thereof, and the second portion 14 may include a carbonless front (CF) coating applied to the second front face 32 thereof. Other construction and structural details of the alternative embodiment, such as indicia areas, preprinted indicia, tape, and the like, could remain as described above.

The operation of such an alternative embodiment would involve manipulating the form 10 to fold the first portion 12 forwardly about the seam 26, so that the first portion 12 overlies the second portion 14, which would precisely line up the preprinted indicia 40, 42. Handwritten of otherwise impressed image marks could then be printed on the first rear face 30 of the first portion 12, which would automatically transfer to corresponding locations on the second front face 32 of the second portion 14. The remainder of the operation of such an alternative form would be substantially the same as described above.

It is further noted that, as mentioned above, if the carbonless transfer coatings on the first and second portions 12, 14 are CFB coatings (such that both of the substantially continuous printable surfaces 18, 20 are coated), then the form 10 may be used by folding the portions 12, 14 together about the seam 26 in either direction to provide for the image transfer. In more detail, with the carbonless transfer coatings comprising CFB coatings, the first portion 12 would include carbonless transfer coatings on both the first front face 28 and the first rear face 30 thereof, and the second portion 14 would include carbonless transfer coatings on both the second front face 32 and the second rear face 34 thereof.

With such versatile carbonless transfer coatings applied thereto, the form 10 could be selectively manipulated to fold the first portion 12 rearwardly about the seam 26 to underlie the second portion 14 (as described above with respect to the depicted embodiment), or to fold the first portion 12 forwardly about the seam 26 to overlie the second portion 14 (as described above with respect to an alternative embodiment), either of which would precisely line up the preprinted indicia 40, 42. Handwritten or otherwise impressed image marks could then be printed on the primary indicia area 36, 38 of the top portion (either the first portion 12 or the second portion 14), and such impressed marks will automatically transfer to the corresponding primary indicia area 36, 38 of the bottom portion (the other of the first portion 12 or the second portion 14), as will be readily appreciated by one of ordinary skill in the art upon review of this disclosure.

Regarding formation of the form 10, an exemplary process involves feeding a first continuous substrate web (corresponding to the first portion 12) along a longitudinal path and feeding a second continuous substrate web (corresponding to the second portion 14) along the same longitudinal path. The first and second webs are aligned in a non-overlapping, edge-to-edge relationship to define the seam 26 therebetween, with the seam 26 extending along and being at least generally parallel to the longitudinal path. In the aligned condition, the first and second webs cooperatively present the opposite substantially continuous printable surfaces 18, 20 described in detail above.

Both the first web and the second web include carbonless transfer coatings 54, 56, respectively, applied to a face thereof, with the coated faces corresponding to the same printable surface 20. In the embodiment depicted, as described in detail above, the first web includes a carbonless front (CF) coating 54 applied to the first rear face 30 thereof, and the second web includes a carbonless back (CB) coating 56 applied to the second rear face 34 thereof.

A continuous streamer of heat-resistant tape 16 is applied to the first and second webs over and along the seam 26 to retain the webs in the edge-to-edge relationship to thereby form a continuous sheet. As described in detail above, the tape 16 is capable of maintaining adhesion without fracturing at ambient temperatures up to one-hundred seventy-five degrees Fahrenheit, and includes a line of weakness preferably in the form of the perforation line 62 defined at least partly along the seam 26 to facilitate folding of the webs relative to one another and easy separation of the webs from one another.

It is noted that the feeding, aligning, and joining of the first and second webs may be accomplished, for example, within a web-type rotary press (not shown), as will be understood by one of ordinary skill in the art upon review of this disclosure. One example of such a press suitable for use in feeding, aligning, and joining the first and second webs is an offset printing press, which can be configured to precisely align multiple webs for joining in anon-overlapping, edge-to-edge relationship, such as the first and second webs of the present invention. The use of alternative press machines or other equipment for the formation process is, of course, within the ambit of the present invention.

As described in detail above, the first and second webs (corresponding to the first and second portions 12, 14, respectively) include primary indicia areas 36, 38, respectively, disposed on opposite sides thereof. Adjacently spaced indicia 40, 42 is printed on the primary indicia areas 36, 38 of the first and second webs. The indicia 40, 42 can be printed by the same offset printing press used to feed, align, and join the webs (such as in a downstream printing operation), or could alternatively be added to a finished sheeted product (such as by printing in an offline laser printer), as will be readily appreciated by one of ordinary skill in the art upon review of this disclosure. In the embodiment shown, the indicia on the first web 40 is the same as the indicia on the second web 42, only reflected about the seam 26, as described in detail above.

It is also noted that the carbonless transfer coatings 54, 56 can be applied to the first and second webs by the same offset printing press used to feed, align, and join the webs discussed above, or could alternatively be preapplied to paper webs of the first and second portions 12, 14 without departing from the teachings of the present invention. Following the formation process outlined above, the continuous sheet can be rolled into a continuous roll, either before or after printing, or can be sheeted into a plurality of individual forms (such as the illustrated form 10), all of which are within the ambit of the present invention.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and access the reasonably fair scope of the present invention as pertains to any apparatus not materially departing from but outside the literal scope of the invention set forth in the following claims.

What is claimed is:

1. A foldable business form printable within a high-heat printer and providing image transfer between portions of the form, said form comprising:
a first portion formed from a first web;
a second portion formed from a second web,
said first and second portions cooperatively forming opposite substantially continuous printable surfaces,
said first and second portions being positioned in a non-overlapping, edge-to-edge relationship with one another to define a seam therebetween,
said first portion presenting a first primary indicia area on one of the printable surfaces and said second portion presenting a second primary indicia area on the other one of the printable surfaces such that the primary indicia areas are located on different portions and on opposite printable surfaces,
said primary indicia areas each including preprinted indicia,
said primary indicia areas being cooperatively oriented such that, when the form is folded about the seam and the portions superimposed, one primary indicia area underlies the other primary indicia area and the preprinted indicia are aligned between respective primary indicia areas,
said first and second portions each including a carbonless transfer coating applied to the same surface of both portions such that, when the preprinted indicia are aligned between respective primary indicia areas, an impressed image created on the primary indicia area of one portion is automatically transferred to a corresponding location on the primary indicia area of the other portion; and
tape retaining said first portion and said second portion in the edge-to-edge relationship,
said tape being heat resistant such that the tape is capable of maintaining adhesion and thereby substantially retaining said first portion and said second portion in the edge-to-edge relationship without fracturing as the form is passed through the printer,
said tape including a line of weakness therein defined at least partly along the seam to facilitate folding of the form at the seam and separation of the portions from one another.

2. The business form as claimed in claim 1,
said carbonless transfer coating on one of the portions comprising a CF coating and said carbonless transfer coating on the other of the portions comprising a CB coating.

3. The business form as claimed in claim 2,
said portion including the CF coating being devoid of any CB or CFB coating being applied thereto.

4. The business form as claimed in claim 3,
said portion including the CB coating being devoid of any CF or CFB coating being applied thereto.

5. The business form as claimed in claim 2,
said first and second portions each being formed of paper with said carbonless transfer coatings being preapplied thereto.

6. The business form as claimed in claim 1,
said carbonless transfer coating on the first portion being located at least partly within the first primary indicia area and said carbonless transfer coating on the second portion being on the surface opposite the second primary indicia area in at least partial alignment therewith.

7. The business form as claimed in claim 6,
said primary indicia areas presenting substantially equal size and shape.

8. The business form as claimed in claim 7,
said preprinted indicia defining a plurality of image spaces configured to receive handwritten annotations thereon.

9. The business form as claimed in claim 8,
said image spaces including a number of closely spaced check boxes in which a small handwritten mark is to be placed.

10. The business form as claimed in claim 1,
said preprinted indicia on the first primary indicia area being reflected about the seam relative to said preprinted indicia on the second primary indicia area such that, when the form is positioned in a flat condition without folding about the seam and the preprinted indicia on the second primary indicia area is oriented right side up, then the preprinted indicia on the first primary indicia area is oriented upside down.

11. The business form as claimed in claim 1,
said first portion including a secondary indicia area on the surface opposite the first primary indicia area such that an image created on the secondary indicia area of the first portion is not transferred to the second portion.

12. The business form as claimed in claim 11,
said carbonless transfer coating on the first portion comprising a CF coating and said carbonless transfer coating on the second portion comprising a CB coating.

13. The business form as claimed in claim 12,
said CF coating being located at least partly within the first primary indicia area and said CB coating being on the surface opposite the second primary indicia area in at least partial alignment therewith.

14. The business form as claimed in claim 1,
said tape being capable of maintaining adhesion without fracturing at all ambient temperatures between the ranges of one-hundred and one-hundred seventy-five degrees Fahrenheit.

15. The business form as claimed in claim 1,
said line of weakness comprising a perforation line.

16. The business form as claimed in claim 1,
said tape being affixed to the first and second portions on the same surface as the carbonless transfer coating.

17. The business form as claimed in claim 1,
said tape including a backing layer and an adhesive.

18. A method of forming a foldable business form product that is printable within a high-heat printer and provides image transferability between portions of the form, said method comprising the steps of:
(a) feeding first and second continuous substrate webs along a longitudinal path, with each of said webs including a carbonless transfer coating applied to a face thereof;
(b) aligning the first and second webs in anon-overlapping, edge-to-edge relationship to define a seam therebetween, with the seam extending along and being at least generally parallel to the path; and
(c) applying a continuous streamer of tape to the webs over and along the seam to retain the webs in the edge-to-edge relationship to thereby form a common continuous sheet having opposite substantially continuous printable surfaces, with the coated faces of the webs being presented along a common one of the printable surfaces so that, when the form is folded at the seam to orient the faces against one another, an impressed image created on one of the webs is automatically transferred to the other one of the webs,
said tape being heat resistant such that the tape is capable of maintaining adhesion and thereby substantially retaining the webs in the edge-to-edge relationship without fracturing when the business product is passed through the printer,
said tape including a line of weakness therein defined at least partly along the seam to facilitate folding of the form at the seam and separation of the webs from one another.

19. The forming method as claimed in claim 18; and
(d) rolling the continuous sheet into a roll to thereby form the business form product.

20. The forming method as claimed in claim 18; and
(d) sheeting the continuous sheet into individual single ply forms to thereby form the business form product.

21. The forming method as claimed in claim 18,
said first web presenting a first primary indicia area on one of the printable surfaces and said second web presenting a second primary indicia area on the other one of the printable surfaces such that the primary indicia areas are located on different webs and on opposite printable surfaces; and
(d) printing indicia on the primary indicia areas of the webs with the printed indicia on one web being reflected about the seam relative to the printed indicia on the other web.

22. The forming method as claimed in claim 21,
said indicia printed on the first web being the same as the indicia printed on the second web.

23. The forming method as claimed in claim 18; and
(d) applying carbonless transfer coating to the faces of the first and second webs, step (d) being performed prior to step (a).
